(19) United States
(12) Patent Application Publication
(10) Pub. No.: US 2008/0088601 A1
(43) Pub. Date: Apr. 17, 2008

(54) CIRCUIT LAYOUT ON A TOUCH PANEL

(75) Inventor: Shun-Ta Chien, Taipei City (TW)

Correspondence Address: SCHNECK & SCHNECK, P.O. BOX 2-E, SAN JOSE, CA, 95109-0005, US

(73) Assignee: TPK TOUCH SOLUTIONS INC., Taipei City (TW)

(21) Appl. No.: 11/957,081

(22) Filed: Dec. 14, 2007

Related U.S. Application Data
(63) Continuation-in-part of application No. 10/847,871, filed on May 19, 2004.

(51) Int. Cl. G06F 3/041

(52) U.S. Cl. 345/173

(57) ABSTRACT

A circuit layout is provided on a touch panel having a transparent glass substrate and a transparent conducting layer coated on a transparent conducting layer coating zone of the glass substrate. A peripheral wiring zone is defined on an area on the glass substrate that is not coated by the transparent conducting layer. The circuit layout includes a first and second circuit. The first circuit is formed of a first plated metal layer through metal sputtering on the transparent conducting layer at positions proximate to the peripheral wiring zone and is electrically connected to the transparent conducting layer to thereby develop a voltage gradient on the transparent conducting layer. The second circuit is formed of a second plated metal layer through metal sputtering or screen printing on the peripheral wiring zone and is electrically connected to the first circuit so as to apply a working voltage across the first circuit.

### CROSS-REFERENCE TO RELATED APPLICATION

This application claims priority from and is a continuation-in-part of U.S. patent application Ser. No. 10/847,871 on May 19, 2004, entitled “Method of Manufacturing Circuit Layout on Touch Panel by Utilizing Metal Plating Technology,” which is hereby incorporated by reference in its entirety.

### TECHNICAL FIELD

The present invention relates to a circuit layout on a touch panel, and more particularly to a circuit layout on a touch panel that includes a first and a second circuit.

### BACKGROUND

On a conventional resistive touch panel, two circuits are provided on a conductive glass thereof, namely a first and a second circuits. The first circuit is electrically connected to a transparent conducting layer, while the second circuit is electrically connected to the first circuit to apply a working voltage across the first circuit and thereby develop a voltage gradient in a zone coated by the transparent conducting layer.

From the known formula for calculating the electrical resistance from the physical dimensions and resistivity of a conductor, it is deduced that the electrical resistance of a conductor is inversely proportional to its cross sectional area. Therefore, in a circuit made of a specific material and having a predetermined layout, the resistance of the circuit may be varied by changing the circuit cross sectional area.

### SUMMARY OF THE INVENTION

In an exemplary embodiment of the present invention, a circuit layout on a touch panel includes a first and a second circuit formed through metal sputtering. Resistances of the two circuits may be controlled by varying a structural width and accordingly, the cross sectional area thereof.

In another exemplary embodiment of the present invention, a circuit layout on a touch panel includes a first circuit formed through metal sputtering, and a second circuit formed through metal sputtering or screen printing after formation of the first circuit. Therefore, resistances of the first and the second circuits are controlled not only by varying their widths and accordingly, their cross sectional areas, but also by using different materials to form the two circuits.

In another exemplary embodiment, the present invention comprises a touch panel which includes a substantially transparent glass substrate having a transparent conducting layer coating zone, a transparent conducting layer coated on the coating zone, and a peripheral wiring zone defined on an area of the glass substrate that is not coated by the transparent conducting layer. A first circuit is formed on the transparent conducting layer at positions proximate to the peripheral wiring zone with a first metal layer electrically coupled to the transparent conducting layer and configured to develop a voltage gradient on the transparent conducting layer. A second circuit is formed on the peripheral wiring zone with a second metal layer electrically coupled to the first circuit and configured to apply a working voltage across the first circuit.

In another exemplary embodiment, the present invention comprises a touch panel which includes a substantially transparent glass substrate having a transparent conducting layer coating zone, a transparent conducting layer coated on the coating zone, and a peripheral wiring zone defined on an area on the glass substrate that is not coated by the transparent conducting layer. A first circuit is formed on the transparent conducting layer at positions proximate to the peripheral wiring zone with a metal layer electrically coupled to the transparent conducting layer and configured to develop a voltage gradient on the transparent conducting layer. A second circuit is formed on the peripheral wiring zone with a conducting film, after formation of the metal layer on the transparent conducting layer, with the second film being electrically coupled to the first circuit and configured to apply a working voltage across the first circuit.

In another exemplary embodiment, the present invention comprises a method of forming a touch panel. The method includes forming a transparent conducting layer over a first portion of a substantially transparent glass substrate and defining a peripheral wiring zone on an area of the glass substrate over a second portion of the glass substrate where the second portion is substantially segregated from the first portion. A first circuit is formed with a metal layer on the transparent conducting layer at a position proximate to the peripheral wiring zone with electrical coupling being provided between the metal layer and the transparent conducting layer. A second circuit is formed on the peripheral wiring zone with a conductive layer with electrical coupling being provided between the conductive layer and the first circuit.

In accordance with various other embodiments of the present invention, there is provided a circuit layout on a touch panel having a transparent glass substrate and a transparent conducting layer which is coated on a transparent conducting layer coating zone of the glass substrate. A peripheral wiring zone is defined on an area on the glass substrate that is not coated by the transparent conducting layer. The circuit layout includes a first circuit and a second circuit. The first circuit is formed of a first plated metal layer through metal sputtering on the transparent conducting layer at positions proximate to the peripheral wiring zone and is electrically connected to the transparent conducting layer to thereby develop a voltage gradient on the transparent conducting layer. The second circuit is formed of a second plated metal layer through metal sputtering or screen printing on the peripheral wiring zone and is electrically connected to the first circuit so as to apply a working voltage across the first circuit.

With the technical means adopted by various embodiments of the present invention, the resistance values for the first and second circuits on a touch panel may be controlled through changing the structural width and thickness of the circuits; and, the first and second circuits may be separately formed in two processes of metal sputtering, so as to change the cross sectional areas thereof. Moreover, the first and second circuits may be selectively made of different materials to vary the resistance thereof. Since the screen printing is relatively simple, the use of screen printing to form the second circuit simplifies the manufacturing process of the circuit layout.

### BRIEF DESCRIPTION OF THE DRAWINGS

The structure and the technical means adopted by the present invention can be best understood by referring to the following detailed description of exemplary embodiments and the accompanying drawings, wherein

FIG. 1 is a partially exploded perspective view showing a circuit layout on a touch panel according a first exemplary embodiment of the present invention;

FIG. 2 is a fully exploded view of FIG. 1;

FIG. 3 is a cross sectional view taken along line 3-3 of FIG. 1;

FIGS. 4 through 12 are cross sectional views showing an exemplary process of manufacturing the circuit layout according to the first exemplary embodiment of the present invention;

FIG. 13 is a cross sectional view showing a circuit layout on a touch panel according to a second exemplary embodiment of the present invention;

FIG. 14 is a cross sectional view showing a circuit layout on a touch panel according to a third exemplary embodiment of the present invention;

FIGS. 15 through 19 are cross sectional views showing a process of manufacturing a circuit layout on a touch panel according to a fourth exemplary embodiment of the present invention;

FIGS. 20 and 21 are cross sectional views showing a process of manufacturing a circuit layout on a touch panel according to a fifth exemplary embodiment of the present invention;

FIG. 22 is a cross sectional view showing a circuit layout on a touch panel according to a sixth exemplary embodiment of the present invention; and

FIG. 23 is a cross sectional view showing a circuit layout on a touch panel according to a seventh exemplary embodiment of the present invention.

### DETAILED DESCRIPTION

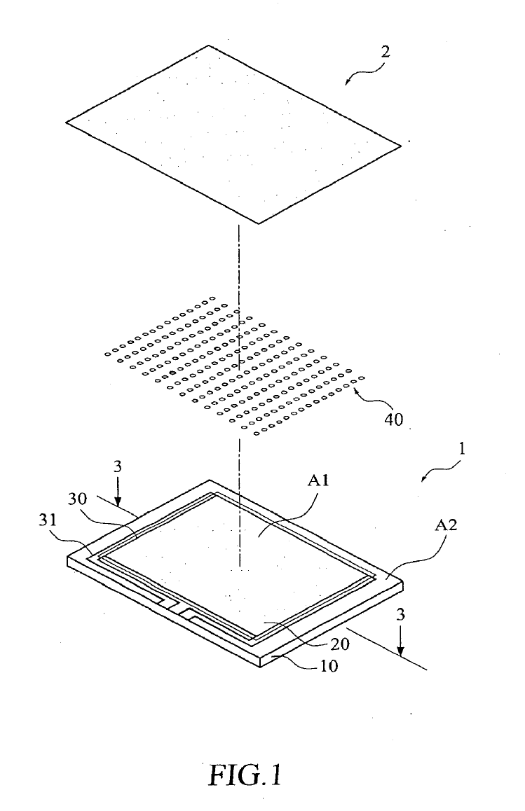

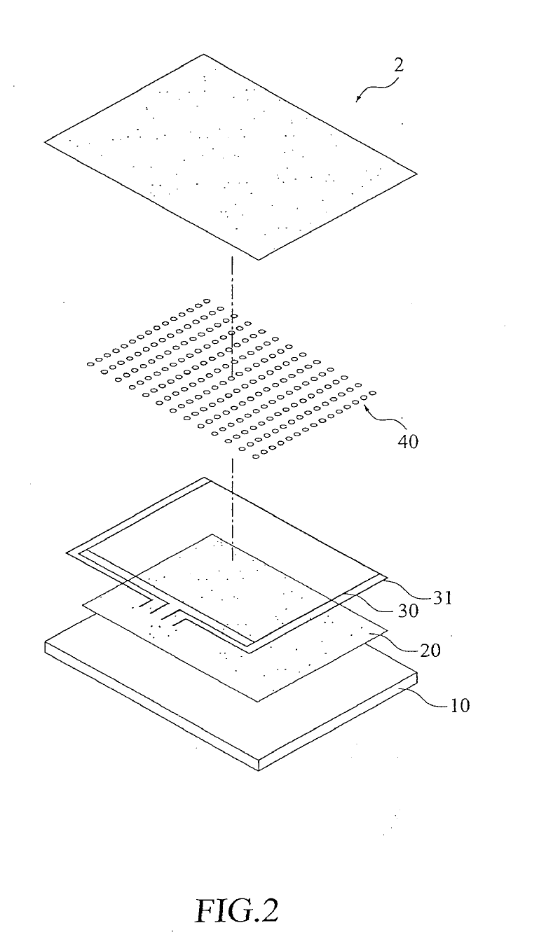

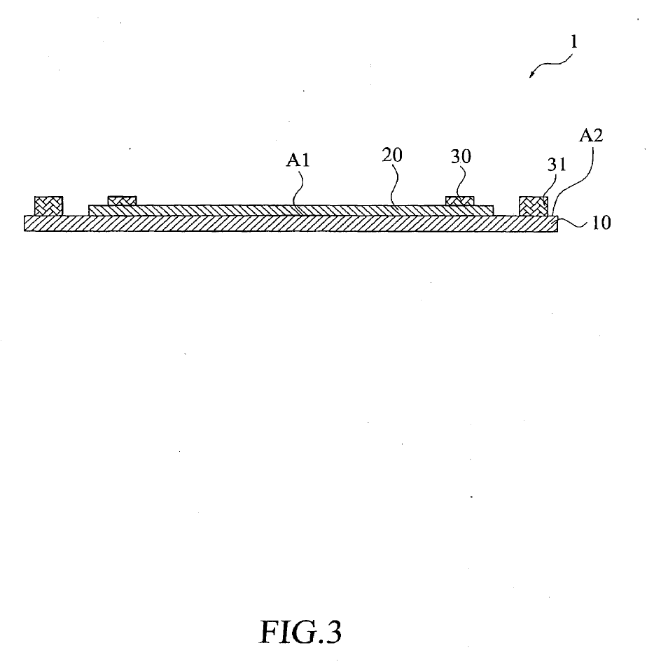

With reference to FIGS. 1 to 3, a circuit layout on a touch panel according to a first embodiment of the present invention is shown. The touch panel includes a conductive glass 1, and a conductive film 2.

The conductive glass 1 includes a substantially transparent glass substrate 10, on which a transparent conducting layer coating zone A1 is defined for coating a transparent conducting layer 20 thereon. The transparent conducting layer 20 may be, for example, an indium tin oxide (ITO) film. The area on the glass substrate 10 that is not coated by the transparent conducting layer 20 is defined as a peripheral wiring zone A2. A first circuit 30 is provided on the transparent conducting layer 20 at positions proximate to the peripheral wiring zone A2. A second circuit 31 is provided on the peripheral wiring zone A2 to electrically connect to two opposite ends of the first circuit 30, so as to apply a working voltage across the first circuit 30. The first circuit 30 is electrically connected to the transparent conducting layer 20 to thereby develop a voltage gradient on the transparent conducting layer 20. Moreover, a plurality of dot spacers 40 are provided on the transparent conducting layer coating zone A1, so that a space is maintained between the conductive glass 1 and the conductive film 2. The conductive film 2 is a layer of electrically conductive film.

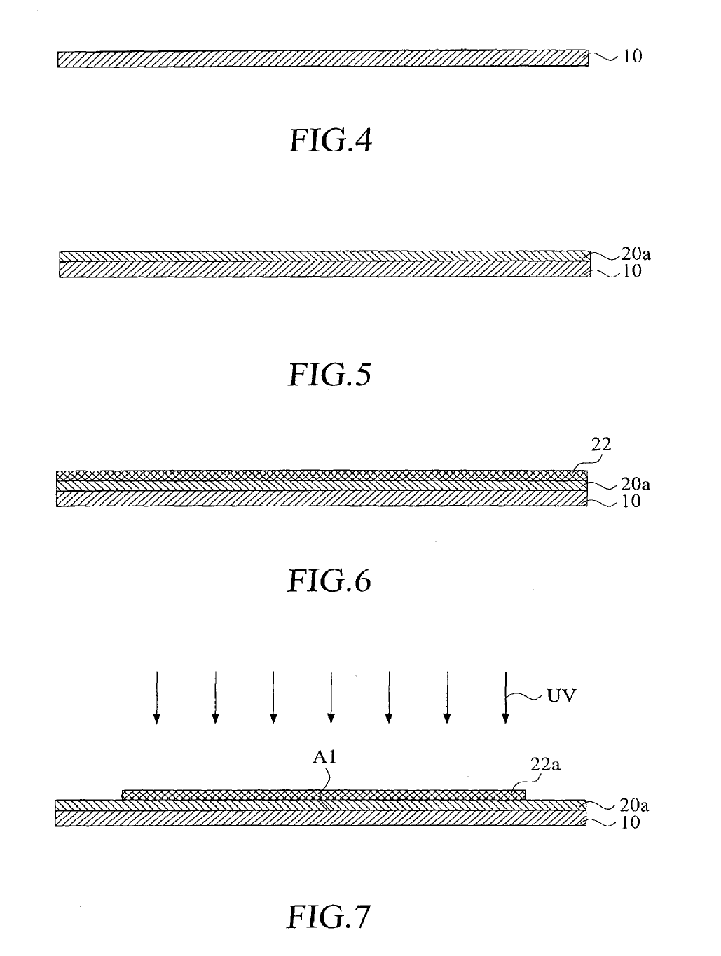

With reference now to FIGS. 4 through 12, cross sectional views of a manufacturing process of the circuit layout on a touch panel is shown according to the first process embodiment of the present invention. As shown in FIGS. 4 and 5, the transparent glass substrate 10 is initially coated on one side with a transparent conducting layer 20a.

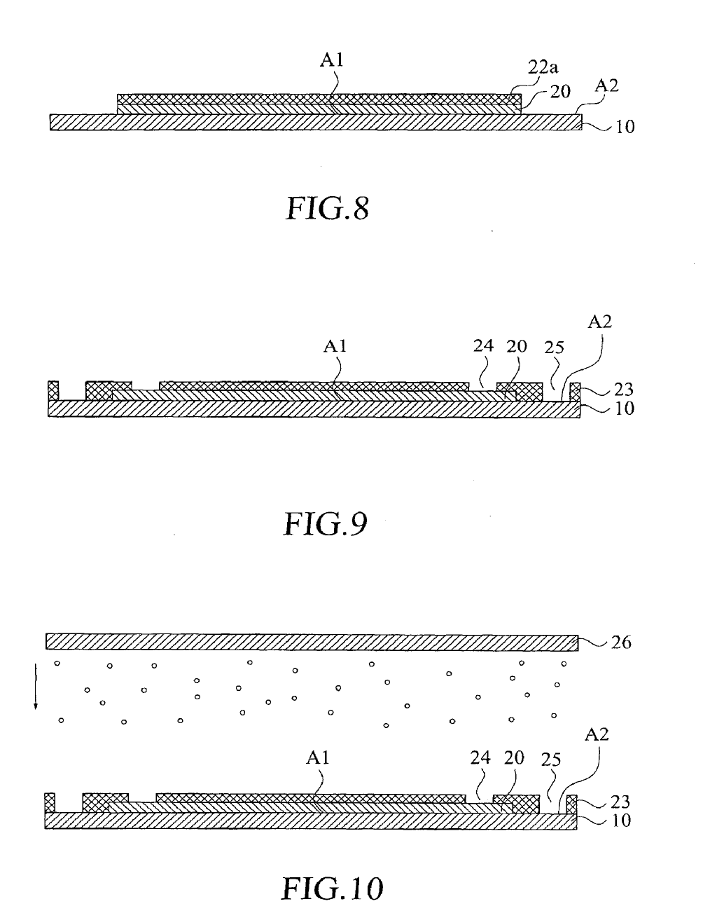

As shown in FIGS. 6 to 8, a layer of photoresist 22 is coated on the initial transparent conducting layer 20a, which covers an area similar to that of the transparent conducting layer 20a (see FIG. 6). After exposure to ultraviolet (UV) light, an area on the photoresist layer 22 that is irradiated by ultraviolet light forms a mask 22a. The remaining area of the photoresist layer 22, that is not irradiated by the ultraviolet light, is removed through developing process to expose the initial transparent conducting layer 20a underneath (see FIG. 7). Through chemical etching, the area of the initial transparent conducting layer 20a not coated by the photoresist layer 22a (that is, the mask) is etched to expose the glass substrate 10, and the exposed part of the glass substrate 10 is defined as the peripheral wiring zone A2; on the other hand, the area of the initial transparent conducting layer 20a covered by the mask 22a is reserved and defined as the transparent conducting layer 20, and the area of the glass substrate 10 immediately below the transparent conducting layer 20 is defined as the transparent conducting layer coating zone A1 (see FIG. 8).

With reference to FIG. 9, the remaining photoresist layer 22a is then removed, and a new layer of photoresist 23 is coated on the exposed transparent conducting layer 20 and the peripheral wiring zone A2. A first wiring area 24 and a second wiring area 25 are defined on the transparent conducting layer 20 and the peripheral wiring zone A2, respectively. The first wiring area 24 has a width similar to that of the second wiring area 25.

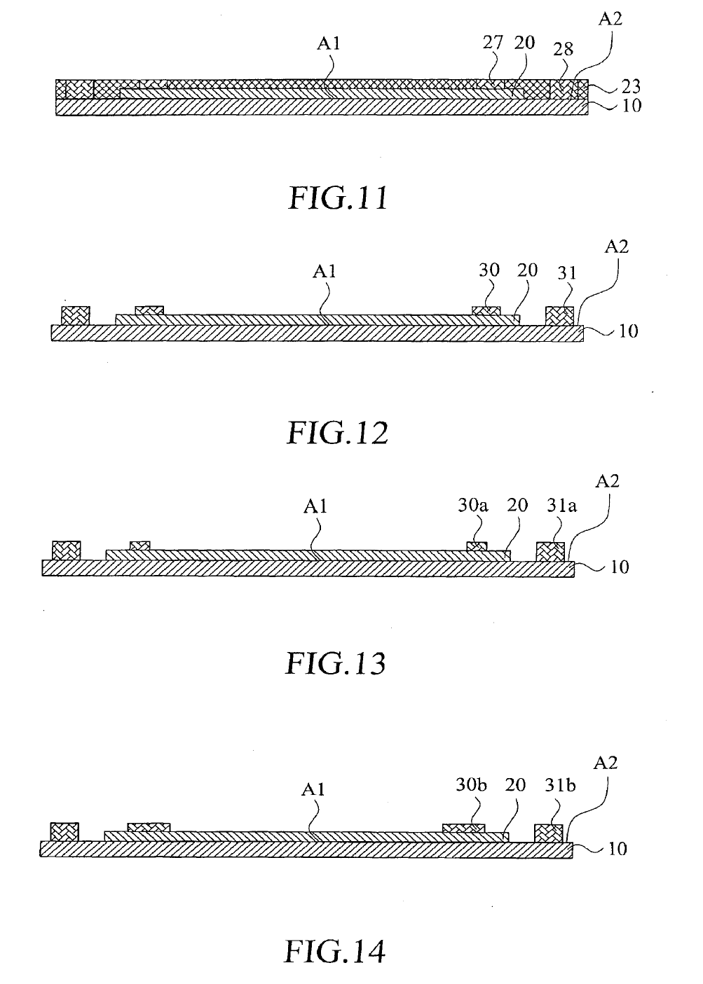

With reference to FIG. 10, in the first exemplary embodiment of the present invention, silver is used as a target 26, and metal sputtering is proceeded to coat silver ions on the first wiring area 24 and the second wiring area 25. When a predetermined thickness of silver ions has been coated on the first and the second wiring areas 24, 25, a first and a second plated metal layer 27, 28 have been produced by metal sputtering respectively on the first and the second wiring areas 24, 25. The first plated metal layer 27 has a structural width similar to that of the second plated metal layer 28, but a structural thickness thinner than that of the second plated metal layer 28, as shown in FIG. 11.

In FIG. 12, the photoresist layer 23 is then removed by wet lift-off or dry lift-off, with the first and the second plated metal layers 27, 28 remaining on the transparent conducting layer 20 and the glass substrate 10 to form the first and the second circuits 30, 31, respectively. The first circuit 30 has a structural width similar to that of the second circuit 31, but a structural thickness thinner than that of the second circuit 31. Therefore, the first circuit 30 has a cross sectional area smaller than that of the second circuit 31. As it can be deduced from the formula for calculating the resistance of a conductor, the first circuit 30 has a per unit length resistance larger than that of the second circuit 31.

FIG. 13 is a cross sectional view showing the circuit layout on a touch panel according to a second exemplary embodiment of the present invention. A first circuit 30a and a second circuit 31a in the second exemplary embodiment are manufactured by a process similar to that of the first exemplary embodiment (see FIGS. 4 to 11). However, the wiring areas for forming the first and the second circuit 30a, 31a have different widths, so that the finally formed first circuit 30a has a structural thickness and a structural width both smaller than those of the second circuit 31a, the two factors (i.e. the width and thickness) making the difference in the cross sectional area even larger, and accordingly, the difference in resistance between the first circuit 30a and the second circuit 31a is enlarged.

FIG. 14 is a cross sectional view showing a circuit layout on a touch panel according to a third exemplary embodiment of the present invention. The process for forming the third exemplary embodiment is similar to that of the first embodiment, except that the wiring area for forming a first circuit 30b has a width larger than that of the wiring area for forming a second circuit 31b, so that the finally formed first circuit 30b has a structural thickness smaller than that of the second circuit 31b but a structural width larger than that of the second circuit 31b, and eventually the first and the second circuits 30b, 31b have a similar cross sectional area, and accordingly, a similar resistance.

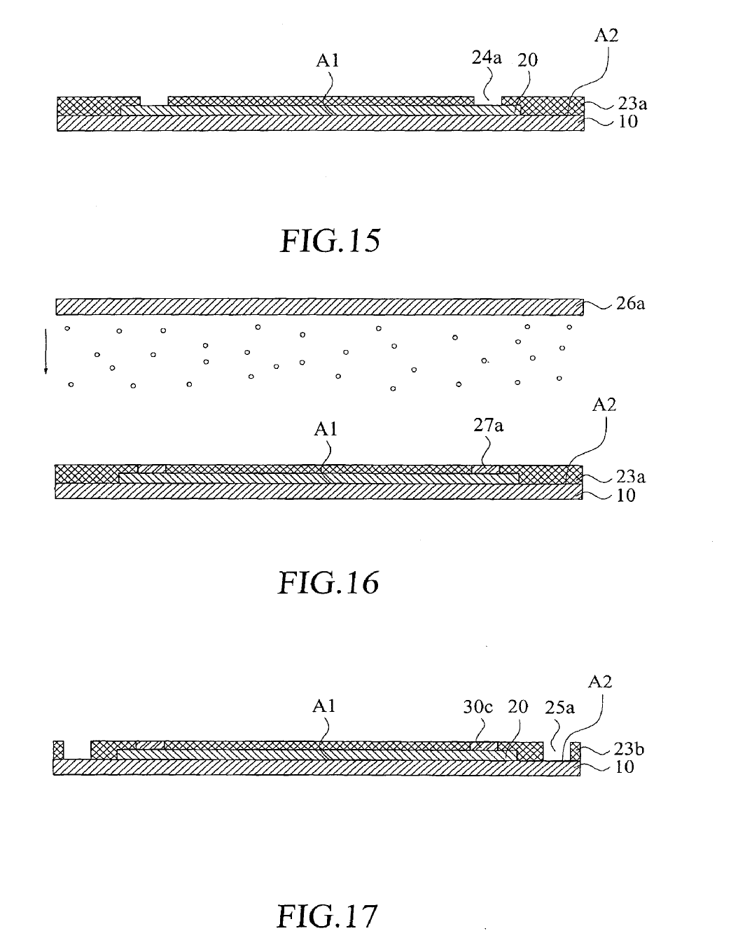

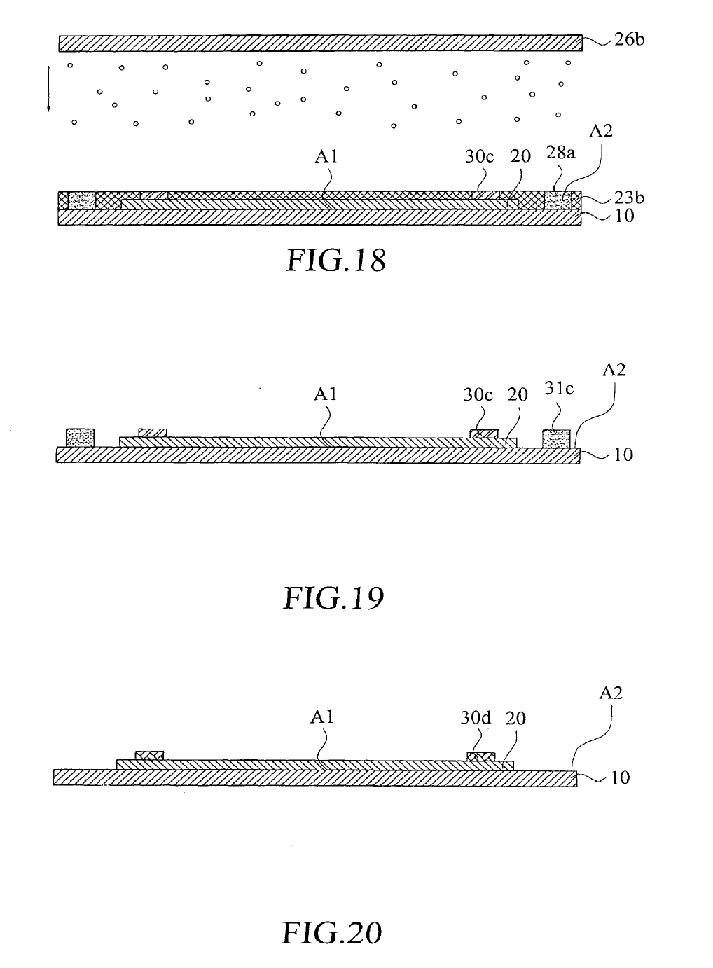

FIGS. 15 through 19 are cross sectional views showing a process of manufacturing the circuit layout on a touch panel according to a fourth exemplary embodiment of the present invention. First, a transparent conducting layer 20 is formed on a glass substrate 10 in the same manner as shown in FIGS. 4 to 8, and a photoresist layer 23a having a first wiring area 24a is coated and patterned on the transparent conducting layer 20 and the peripheral wiring zone A2 (see FIG. 15). Then, a first target 26a is used in a first metal sputtering to form a first plated metal layer 27a in the first wiring area 24a (see FIG. 16). Thereafter, the photoresist layer 23a is removed, and a new photoresist layer 23b defining a second wiring area 25a is coated and patterned on the exposed transparent conducting layer 20 and peripheral wiring zone A2 (see FIG. 17). A second target 26b of another material different from that of the first target 26a is then used in a second metal sputtering to form a second plated metal layer 28a on the second wiring area 25a (see FIG. 18). Finally, as shown in FIG. 19, the photoresist layer 23b is removed, and first and second circuits 30c, 31c are left by the first and the second plated metal layers 27a, 28a on the transparent conducting layer 20 and the glass substrate 10, respectively. The first and the second circuits 30c, 31c are different in material, and the second circuit 31c is electrically connected to the first circuit 30c.

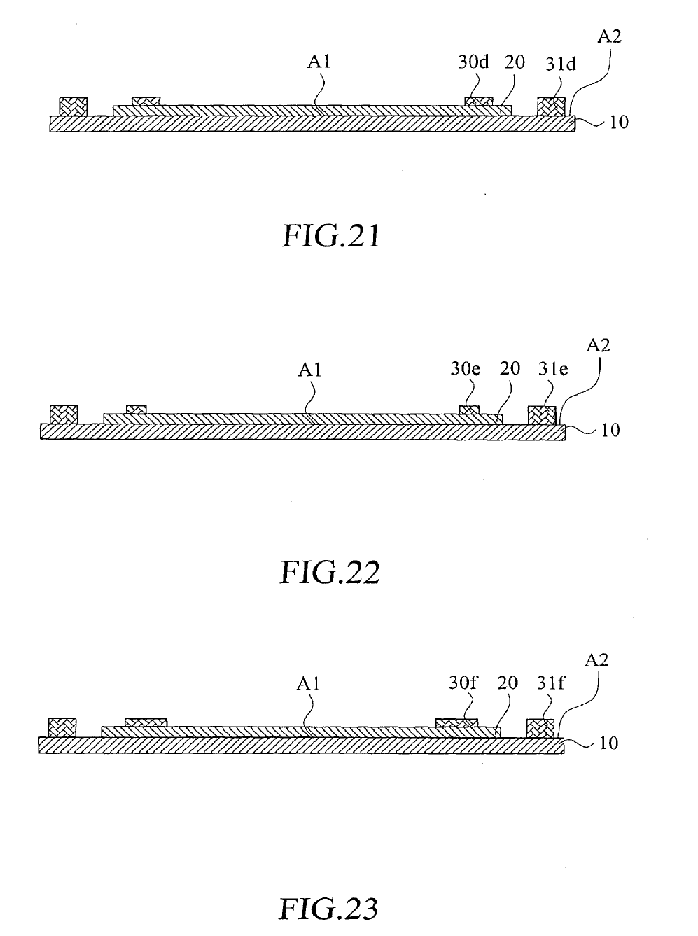

FIGS. 20 and 21 depict cross sectional views showing a process of manufacturing the circuit layout on a touch panel according to a fifth exemplary embodiment of the present invention. First, a transparent conducting layer 20 with a first circuit 30d is formed on a glass substrate 10 in the same manner as that used in the fourth exemplary embodiment (see FIG. 20). Then, through screen printing, silver paste is printed on a predetermined position on the peripheral wiring zone A2 to produce a layer of conducting film, which forms a second circuit 31d having a structural width similar to that of the first circuit 30d and a structural thickness larger than that of the first circuit 30d (see FIG. 21). Moreover, the second circuit 31d is electrically connected to the first circuit 30d.

FIG. 22 is a cross sectional view showing a process of manufacturing the circuit layout on a touch panel according to a sixth exemplary embodiment of the present invention. In the sixth exemplary embodiment, the circuit layout on the touch panel is formed in a manner similar to that used in the fifth exemplary embodiment, except that a layer of conducting film produced by screen printing to form a second circuit 31e has a structural thickness and a structural width larger than those of a first circuit 30e. Again, the second circuit 31e is electrically connected to the first circuit 30e.

FIG. 23 is a cross sectional view showing a process of manufacturing the circuit layout on a touch panel according to a seventh exemplary embodiment of the present invention. In the seventh exemplary embodiment, the circuit layout on the touch panel is formed in a manner similar to that used in the sixth exemplary embodiment, except that a layer of conducting film produced by screen printing to form a second circuit 31f has a structural thickness larger than that of a first circuit 30f but a structural width smaller than that of the first circuit 30f. The second circuit 31f is electrically connected to the first circuit 30f; and the first and the second circuits 30f, 31f have similar cross sectional areas to thereby have similar resistances.

Although the present invention has been described with reference to the preferred embodiments thereof and the best modes for carrying out the invention, it is apparent to those skilled in the art that a variety of modifications and changes may be made without departing from the scope of the present invention which is intended to be defined by the appended claims.

What is claimed is:

1. A touch panel comprising:
a substantially transparent glass substrate having a transparent conducting layer coating zone;
a transparent conducting layer coated on the transparent conducting layer coating zone;
a peripheral wiring zone defined on an area of the glass substrate that is not coated by the transparent conducting layer;
a first circuit formed with a first metal layer on the transparent conducting layer at positions proximate to the peripheral wiring zone, the first metal layer being electrically coupled to the transparent conducting layer and configured to develop a voltage gradient on the transparent conducting layer; and
a second circuit formed with a second metal layer on the peripheral wiring zone, the second metal layer being electrically coupled to the first circuit and configured to apply a working voltage across the first circuit.

2. The touch panel of claim 1 wherein the first metal layer and the second metal layer are each plated layers formed from sputtered metal.

3. The touch panel of claim 1 wherein the first and the second metal layers have a similar structural width and the first metal layer has a structural thickness smaller than a thickness of the second metal layer.

4. The touch panel of claim 1 wherein the first metal layer has a structural thickness and a structural width both smaller than a structural thickness and a structural width of the second metal layer.

5. The touch panel of claim 1 wherein the first metal layer has a structural thickness smaller than a thickness of the second metal layer and a structural width larger than a thickness of the second metal layer.

6. The touch panel of claim 1 wherein the first metal layer is produced in a first metal sputtering to form the first circuit and the second metal layer is produced in a second metal sputtering to form the second circuit to electrically couple to the first metal layer.

7. The touch panel of claim 1 wherein the first metal layer and the second metal layer are formed simultaneously in a single metal sputtering operation.

8. A touch panel comprising:
a substantially transparent glass substrate having a transparent conducting layer coating zone;
a transparent conducting layer coated on the transparent conducting layer coating zone;
a peripheral wiring zone defined on an area on the glass substrate that is not coated by the transparent conducting layer;
a first circuit formed on the transparent conducting layer at positions proximate to the peripheral wiring zone with a metal layer electrically coupled to the transparent conducting layer and configured to develop a voltage gradient on the transparent conducting layer; and
a second circuit formed on the peripheral wiring zone with a conducting film after formation of the metal layer on the transparent conducting layer, the second film being electrically coupled to the first circuit and configured to apply a working voltage across the first circuit.

9. The touch panel of claim 8 wherein the metal layer is a plated metal formed from metal sputtering.

10. The touch panel of claim 8 wherein the conducting film is formed by screen printing.

11. The touch panel of claim 8 wherein the metal layer has a structural width similar to that of the conducting film and a structural thickness less than that of the conducting film.

12. The touch panel of claim 8 wherein the metal layer has a structural thickness and a structural width both less than a structural thickness and a structural width of the conducting film.

13. The touch panel of claim 8 wherein the metal layer has a structural thickness smaller than that of the conducting film and a structural width larger than that of the conducting film.

14. A method of forming a touch panel, the method comprising:
forming a transparent conducting layer over a first portion of a substantially transparent glass substrate;
defining a peripheral wiring zone on an area of the glass substrate over a second portion of the glass substrate, the second portion being substantially segregated from the first portion;
forming a first circuit with a metal layer on the transparent conducting layer at a position proximate to the peripheral wiring zone;
providing electrical coupling between the metal layer and the transparent conducting layer;
forming a second circuit on the peripheral wiring zone with a conductive layer; and
providing electrical coupling between the first circuit and the second circuit.

15. The method of claim 14 wherein the metal layer and the conductive layer are each formed by metal sputtering.

16. The method of claim 14 wherein the metal layer is formed by metal sputtering.

17. The method of claim 14 wherein the conductive layer is formed from a conductive film.

18. The method of claim 17 wherein the conductive film is formed by screen printing.

19. The method of claim 14 further comprising:
forming the metal layer and the conductive layer to have similar structural widths; and
forming the metal layer to have a structural thickness less than a thickness of the conductive layer.

20. The method of claim 14 further comprising forming the metal layer to have a structural thickness and a structural width both smaller than a structural thickness and a structural width of the conductive layer.

21. The method of claim 14 further comprising forming the metal layer to have a structural thickness smaller than a thickness of the conductive layer and a structural width larger than a width of the conductive layer.
